(19) United States
(12) Patent Application Publication
(10) Pub. No.: US 2026/0311682 A1
(43) Pub. Date: Oct. 8, 2026

(54) METHOD FOR SYNTHESIZING AN AUDIO WAVEFORM FROM A TEXT DESCRIPTION

(71) Applicants: Dolby Laboratories Licensing Corporation, San Francisco, CA (US); Dolby International AB, Dublin (IE)

(72) Inventors: Hao-Wen DONG, LaJolla, CA (US); Xiaoyu LIU, Dublin, CA (US); Gautam BHATTACHARYA, Quebec (CA); Jordi PONS PUIG, Olot (ES); Santiago PASCUAL, Barcelona (ES); Joan SERRA, Barcelona (ES)

(73) Assignees: Dolby Laboratories Licensing Corporation, San Francisco, CA (US); Dolby International AB, Dublin (IE)

(21) Appl. No.: 19/478,184

(22) PCT Filed: Apr. 25, 2024
(86) PCT No.: PCT/US2024/026329

§ 371 Date: Oct. 23, 2025

Related U.S. Application Data
(60) Provisional application No. 63/588,010, filed on Oct. 5, 2023.
(60) Provisional application No. 63/554,808, filed on Feb. 16, 2024.

(30) Foreign Application Priority Data
Apr. 27, 2023 (ES) P202330333

(51) Int. Cl. G10L 13/047; G10L 13/08; G10L 21/10

(52) U.S. Cl. CPC G10L 13/047; G10L 13/08; G10L 21/10

(57) ABSTRACT

An aspect of the present disclosure relates to a method for synthesizing an audio waveform from a text description indicating a desired sound, the method comprising: determining a text embedding from the text description; determining an image embedding from the text embedding; synthesizing a spectrogram by inputting the image embedding to a generative model trained to synthesize a spectrogram given an input image embedding; and converting the synthesized spectrogram to the audio waveform.

### CROSS-REFERENCE TO RELATED APPLICATIONS

This application claims the benefit of priority from Spanish Application No. P202330333, filed on 27 Apr. 2023, U.S. Provisional Application No. 63/588,010 filed on 5 Oct. 2023, and U.S. Provisional Application No. 63/554,808 filed on 16 Feb. 2024, each of which is incorporated by reference herein in its entirety.

### TECHNICAL FIELD

The present disclosure relates to a method, a system and a computer program product for synthesizing an audio waveform from a text description.

### BACKGROUND

Text-to-audio synthesis refers to the task of generating an audio given a text description of the desired sound. This task has wide applicability in areas such as content creation, sound engineering, etc.

With the advance of generative modeling and language-audio contrastive learning, various deep learning-based text-to-audio synthesis systems have recently merged. Existing text-to-audio algorithms rely on large scale labeled text-audio pairs for training such systems. For example, the AudioLDM (Liu et al., “AudioLDM: Text-to-Audio Generation with Latent Diffusion Models”, https://arxiv.org/abs/2301.12503v1) utilizes millions of text-audio pairs, and MusicLM (Agostinelli et al., “MusicLM: Generating Music From Text”, https://arxiv.org/abs/2301.11325v1) collects tens of millions of text-music pairs for training their text-to-music model. Labelling general audio (such as mixtures of sound effects, music, speech, etc.) with accurate textual captions is however very laborious.

Despite extensive human annotation efforts, the current largest public text-audio dataset known to the inventors contains around 630 k text-audio pairs. Given the relatively scarce availability of text-audio data, as compared to text-image data, it remains unclear whether it is feasible to scale up text-audio datasets to a size comparable with large scale text-image datasets, e.g., the LAION-5B dataset, which contains 5.85 billion text-image pairs.

### SUMMARY

In view of the preceding, it would be desirable to provide a deep learning-based approach allowing synthesis of an audio waveform from a text description, which does not rely on text-audio data for training but instead may be trained using image and audio data, which is relatively easier to obtain than text-audio data.

According to a first aspect of the present disclosure there is provided a method for synthesizing an audio waveform from a text description indicating a desired sound, the method comprising: determining a text embedding from the text description; determining an image embedding from the text embedding; synthesizing a spectrogram by inputting the image embedding to a generative model trained to synthesize a spectrogram given an input image embedding; and converting the synthesized spectrogram to the audio waveform.

According to the method of the first aspect, the spectrogram may thus be generated by a generative model trained to synthesize a spectrogram given an image embedding, rather than a text embedding. Since the image embedding input to the generative model is determined from a text embedding determined from a text description, and the generative model is trained to synthesize a spectrogram given an image embedding, the method is not dependent on any text-audio pairs, neither during inference nor training. Obtaining video and text-image data is relatively easier than obtaining text-audio pairs, which facilitates training of the generative model. The method may hence obviate the need for laborious labelling of large text-audio training datasets.

By synthesizing a spectrogram which in turn is converted to the audio waveform, the generative model may operate in a lower dimensional space, compared to directly synthesizing the audio waveform. This may reduce the complexity and computational requirements of the generative model.

The generative model trained to synthesize the spectrogram may in the following be termed “the second generative model”, to distinguish from other generative models described herein.

In some embodiments, the text embedding may be generated using a text encoder trained to map an input text description to a text embedding. The text encoder may more specifically be trained to map an input text description to a text embedding in a latent space shared with image embeddings used to train the second generative model to synthesize a spectrogram. The text embedding may thus reflect a similar underlying data structure as the image embeddings used to train the second generative model. This indicates that the text encoder, during inference, may provide a text embedding which, by virtue of being within the shared latent text-image embeddings space, in principle, can be used interchangeably with the image embedding, i.e. in a zero-shot modality transfer. However, it has been observed that the different modalities of text and images tend to produce a text-image modality gap in the shared latent space. Since the second generative model is trained to generate a spectrogram given an image embedding (i.e. without relying on any text embedding) the spectrogram generation may be especially sensitive to such a gap. By determining an image embedding from the text embedding and using the determined image embedding as input to the second generative model, the spectrogram synthesis may be guided using an embedding closer to the image embeddings used during training of the second generative model. Thereby, performance degradations due to a text-image modality gap that may exist between a text embedding and image embeddings of a training dataset may be reduced.

The image embeddings used to train the second generative model may be generated using an image encoder trained to map an input image to an image embedding in the latent space. The text encoder and the image encoder may be trained jointly using a contrastive loss. Using a training dataset of text-image pairs, the text encoder and the image encoder may thus be trained to predict matched text-image pairs.

The text encoder may be a Contrastive Language-Image Pre-Training (CLIP) text encoder. The image encoder may be a CLIP image encoder. That is, the text encoder and the image encoder may be respective encoders of a CLIP model. The second generative model may accordingly be trained to synthesize a spectrogram given an input CLIP image embedding.

In some embodiments, the text embedding may be a CLIP text embedding and the second generative model may be trained to synthesize a spectrogram given a CLIP image embedding.

In some embodiments, the image embedding is determined using a first generative model (i.e. different from the second generative model) trained to convert an input text embedding to an image embedding. Use of a generative model allows imparting a generative character to the generation of the image embedding.

As mentioned above, even if the text embedding and the image embeddings used to train the second generative model are in a shared latent space, there may in practice be a gap between the text and image modalities. This may be observed also for contrastively trained text and image encoders, such as of the CLIP model. Hence, the use of the first generative model allows such a gap to be reduced by producing an image embedding closer to the image embeddings used during training of the second generative model, than the text embedding.

Determining the image embedding from the text embedding may comprise sampling N image embeddings from a distribution of image embeddings generated by the first generative model given the text embedding as input and selecting the image embedding out of the N image embeddings with a larger similarity to the text embedding. The image embedding may thus be determined by sampling (e.g. randomly) the distribution of image embeddings and selecting the image embedding closest to the text embedding. The selected image embedding may be the image embedding out of the N image embeddings with the larger cosine similarity to the text embedding. Similarity with the text embedding may thus be determined without being influenced by a potential separation (e.g. Euclidean) within the latent space.

The first generative model may be a prior. A model of image embeddings may hence be learned by the “prior” (interchangeably “prior model”) and used to determine the image embedding from the text embedding. The prior may for instance be a diffusion prior. The image embedding may hence be determined using a diffusion-based process.

The prior may be trained to model a distribution of image embeddings generated by the image encoder, conditioned on text embeddings generated by the text encoder. The prior may thus be used to predict an image embedding of a matched text-image pair given the text embedding of the matched text-image pair as input.

In particular, the prior may be trained to generate a CLIP image embedding given an input CLIP text embedding.

Instead of using a generative model, in some embodiments, determining the image embedding comprises retrieving K≥1 image embeddings from a set of image embeddings, wherein the K retrieved image embeddings are the K image embeddings with the largest cosine similarity with respect to the text embedding out of the set of image embeddings, wherein the image embedding is determined based on the K retrieved image embeddings. Hence, the image embedding may in a computationally efficient manner be determined using a retrieval-based approach. The set of image embeddings may comprise image embeddings which are known to be relatively close to image embeddings used to train the second generative model (i.e. the generative model trained to synthesize the spectrogram). The set of image embeddings may in particular comprise image embeddings used to train the second generative model.

The number of retrieved image embeddings may be K=1, wherein the image embedding (i.e. the image embedding to be input to the second generative model) may be determined as the image embedding out of the set of image embeddings with the largest cosine similarity with respect to the text embedding.

The number of retrieved image embeddings may be K>1, wherein the image embedding (i.e. the image embedding to be input to the second generative model) may be determined as the average of the retrieved K image embeddings, or may be randomly sampled from the retrieved K image embeddings. A degree of generative character may thus be imparted to the determination image embedding, without relying on a generative model.

The second generative model synthesizing the spectrogram may comprise a diffusion decoder model, a generative adversarial network (GAN) or an autoregressive model, wherein the image embedding is input as a condition vector to the second generative model.

The second generative model may be trained to synthesize a Mel spectrogram. A Mel spectrogram enables a compressed spectrogram representation, thus further reducing the complexity of the synthesis task of the second generative model.

The synthesized spectrogram may be converted to the audio waveform by inputting the synthesized spectrogram to a third generative model trained to convert an input spectrogram to an audio waveform. Spectrogram-to-waveform conversion is especially suited for a generative approach, e.g. in that new waveforms not present in the original training dataset may be generated. This may be a desired property in content creation, among others.

The third generative model may comprise a diffusion model, a generative adversarial network or an autoregressive model.

In some embodiments, the second generative model (i.e. the generative model trained to synthesize a spectrogram) is trained using spectrograms and image embeddings generated from video frames paired with audio. The second generative model may hence be trained using audio-visual data derived from a training data set of videos.

Training the second generative model may comprise:
extracting a video frame and a sequence of audio frames from a video of a training dataset of videos comprising audio sound and video frames of an object;
converting the sequence of audio frames to a spectrogram;
determining a training image embedding based on the extracted video frame; and
training the generative model to synthesize the spectrogram using the training image embedding as a condition vector.

The training of the second generative model does hence not require access to any image or audio captions. Videos depicting various types of sound-emitting objects (i.e. the objects being the sound sources of the videos) is readily available, e.g. on the Internet. The second generative model may accordingly leverage such video data sets for training, without need for additional labelling of the videos, in order to enable the text-based audio synthesis as set out herein. The training image embedding may be determined using the aforementioned image encoder, e.g. a CLIP image encoder. The training image embedding may in particular be a CLIP image embedding.

The training may comprise extracting a sequence of video frames from the video, determining a sequence of training image embeddings from the extracted sequence of video frames, and determining the training image embedding as an average image embedding of the sequence of training image embeddings. This may make the training more robust and reduce the impact of divergent and non-representative image frames in case such appear in the video training dataset.

The training image embedding may be determined using the image encoder trained jointly with the text encoder used during inference, as discussed above. The neural network model may be a contrastive model. In particular, the image encoder may be an image encoder of a CLIP model.

According to a second aspect there is provided a system for synthesizing an audio waveform from a text description, the system configured to implement the method according to the first aspect.

According to a third aspect there is provided a computer program product comprising computer program code portions configured to perform the method according to the first aspect when executed on a computer processor.

The second and third aspects may feature the same effects and advantages as discussed with reference to the method of the first aspect. Any functions described in relation to a method, may have corresponding features in a system or a computer program product.

### BRIEF DESCRIPTION OF THE DRAWINGS

Aspects of the present disclosure will be described in more detail with reference to the appended drawings, showing exemplary embodiments.

FIG. 1 is a flow chart of a method for synthesizing an audio waveform from a text description.

FIG. 2 is a schematic block diagram of a system for implementing the method of FIG. 1.

FIG. 3 is a flow chart of a method for training a generative model for synthesizing an audio waveform from an image embedding.

FIG. 4 is a schematic block diagram of a system implementing the training method of FIG. 3.

FIG. 5 shows a schematic block diagram of an example system at training time.

FIG. 6 shows a schematic block diagram of an example system at testing time.

FIG. 7 illustrates a schematic block diagram of an example device, system or architecture that may be used to implement aspects of the present disclosure.

### DETAILED DESCRIPTION

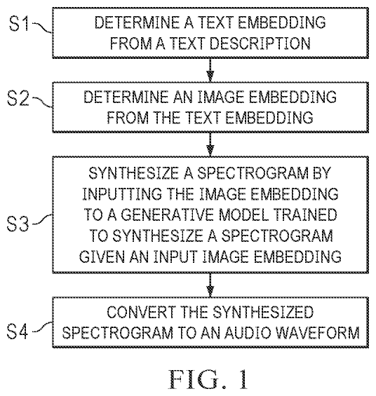

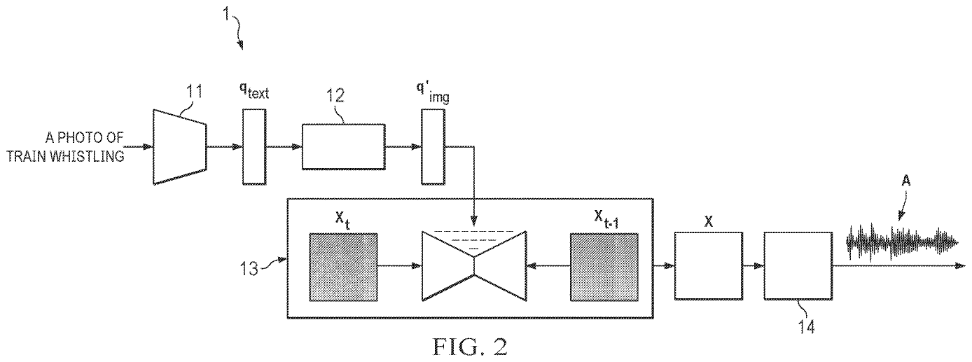

A method for synthesizing an audio waveform from a text description in accordance with the present disclosure will now be described with reference to the flow chart of FIG. 1 and a deep learning-based system 1 of FIG. 2. The system 1 comprises a trained neural network model configured as a text encoder 11 for determining a text embedding qtext from a text description, a first generative model 12 for determining an image embedding q'img from the text embedding qtext, a second generative model 13 for synthesizing a spectrogram X, and a third generative model 14 for converting the synthesized spectrogram X to the audio waveform A.

At S1, a text embedding qtext is determined from the text description by the text encoder 11. The text encoder 11 is trained to map the text description to a text embedding in a latent space. The latent space may more specifically be shared with image embeddings used to train the second generative model 13.

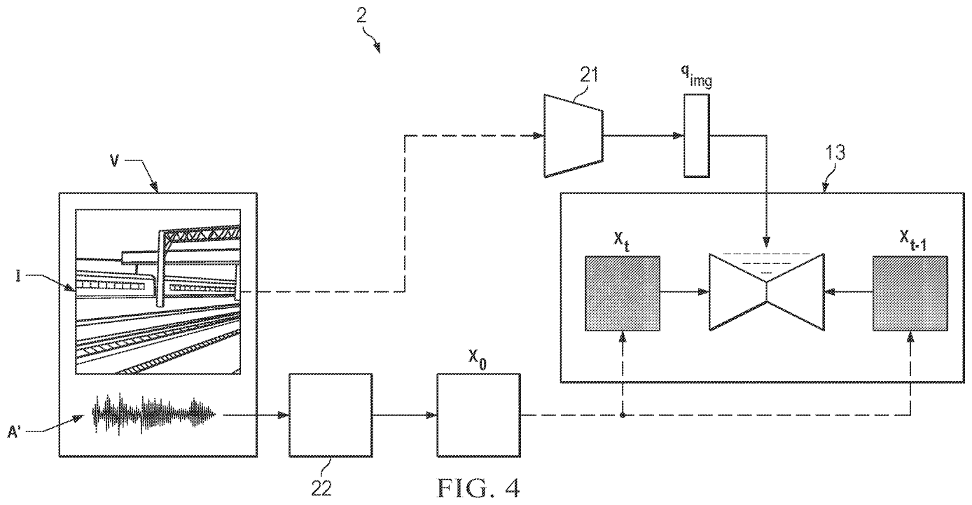

As will be discussed in further detail in the following, the second generative model 13 may be trained using image embeddings generated using an image encoder (e.g. image encoder 21 shown in FIG. 4). In the following the image embeddings generated by the image encoder 21 are denoted qimg. Since these image embeddings are used to train the second generative model 13 they may interchangeably be referred to as training image embeddings qimg. The image encoder 21 may be trained to map an input image to an image embedding qimg in the same latent space as the text embeddings qtext generated by the text encoder 11. This may be achieved by training the text encoder 11 and the image encoder 21 jointly, e.g. using a contrastive loss. The text encoder 11 and the image encoder 21 may be trained using a training dataset of matched text-image pairs such that the text encoder 11 and the image encoder 21 may learn to predict matched text-image pairs, i.e. correct pairings of a text and an image. More specifically, the text encoder and the image encoder may be trained to generate text and image embeddings qtext, qimg such that that text and image embeddings of a mismatched text-image pair has a lower cosine similarity than text and image embeddings of a matched text-image pair.

It is not a prerequisite of the methods and systems of the present disclosure to actually train a text encoder 11 and an image encoder 21. Instead, the text encoder 11 and the image encoder 21 may be a text encoder and an image encoder of any suitable existing pretrained language-vision model. An example is the Contrastive Language-Image Pre-Training (CLIP) model (Radford et al., “Learning Transferable Visual Models From Natural Language Supervision”, arXiv:2103.00020, https://doi.org/10.48550/arXiv.2103.00020). The CLIP model is a pretrained model, trained on a very large dataset of image-text pairs using a contrastive loss such that text descriptions and images are mapped to a shared latent space such that the text and image embeddings of a mismatched text-image pair has a lower cosine similarity than text and image embeddings of a matched text-image pair. Accordingly, in some implementations the text encoder 11 may be a CLIP text encoder trained to determine a CLIP text embedding qtext from a text description, and the image encoder 21 generating the image embeddings qimg used to train the second generative model 13 may be a CLIP image encoder.

The text description input to the text encoder 11 may for example be obtained from a text file including the text description and stored in a memory of a computing system implementing the system 1. The text description may also be obtained as an interactive user input, e.g. entered in an input box or at a prompt of a user interface of the computing system.

While the aim is to synthesize audio, the text encoder 11 may as discussed above be a text encoder of a language-vision model, such as CLIP. Hence, to improve the relevance of the text embedding the text description may as shown in FIG. 2 be input to the text encoder 11 with the syntax “a photo of [label]”, where [label] is a label or descriptor indicating the type of audio that is to be synthesized (e.g. in the illustrated example “whistling train”). However, as may be appreciated the specific syntax of the text description may depend on both the dataset used to train the text encoder 11 and the labels of the dataset used to train the second generative model 13, to be further discussed below. In any case, the text description may typically include a natural language input descriptive of the desired sound.

At S2, an image embedding q'img is determined from the text embedding qtext by the first generative model 12. The first generative model 12 is trained to generate an image embedding q'img given an input text embedding qtext. The input text embedding qtext may thus be converted to an image embedding q'img. It is here noted that an image embedding generated by the first generative model 12 is denoted q'img whereas an image embedding generated by the image encoder 21 during training of the second generative model 13 (i.e. a training image embedding) is denoted qimg. Even though the text encoder 11 (e.g. CLIP text encoder) is trained to map, for example, the text description “dog” to a text embedding close to an image embedding for a photo of “a dog” generated by the image encoder 21 in the embedding space, in practice it turns out the text embedding will typically not be close enough to be used directly as input to the second generative model 13 to synthesize a spectrogram X of an audio waveform with the desired sound. Therefore, the first generative model 12 is introduced in the system 1 as a way to generate “improved” image embeddings q'img closer to their corresponding training image embeddings qimg than the text embeddings qtext.

The first generative model 12 may more specifically be a prior model, or prior, trained to model a distribution of image embeddings q'img generated by the image encoder 21 (e.g. CLIP image embeddings), conditioned on text embeddings qtext generated by the text encoder 11 (e.g. CLIP text embeddings). The first generative model 12, i.e. the prior, may thus be used to predict an image embedding q'img of a matched text-image pair given the text embedding qtext of the matched text-image pair as input. The prior may be a diffusion prior, which lends itself for a computationally efficient implementation. However, other generative priors are also possible, such as an autoregressive prior.

While it is possible to train the prior from scratch, e.g. using a training dataset of matched text-image pairs or text-image embeddings tailored to be relevant for the audio synthesis task, it is also possible to use a pretrained prior, such as the transformer-based diffusion prior model obtainable at https://huggingface.co/laion/DALLE2-PyTorch, which uses the CLIP model.

Using the first generative model 12, an image embedding q'img to be used as input (e.g. condition vector) to the second generative model 13 may be determined by sampling N≥1 image embeddings {q'img,1, . . . , q'img, N} from a distribution of image embeddings {q'img}D generated by the first generative model 12 given the text embedding qtext as input, and selecting the image embedding out of the N image embeddings {q'img,1, . . . , q'img,N≥1} with a larger similarity to the text embedding qtext as the input to the second generative model 13. A cosine similarity provides a convenient and relevant metric for evaluating the similarity. As may be appreciated, in an implementation wherein N=1, the first generative model 12 may be run (i.e. executed) once to generate an image embedding q'img from the text embedding qtext, which in turn may be used as input to the second generative model 13. In an implementation wherein N>1, the first generative model 12 may be run N times to generate N image embeddings q'img,1, . . . , q'img,N (i.e. a distribution of N image embeddings) from the (single) text embedding qtext. The image embedding with the larger cosine similarity to the text embedding qtext among the N image embeddings may then be selected as the image embedding q'img to be used as input to the second generative model 13.

As an alternative to generating the image embedding q'img to be used as input to the second generative model 13 using a first generative model 12 implementing a prior, a retrieval-based approach may be used. The block diagram of FIG. 2 is representative also for such an implementation given that reference sign 12 instead indicates an image embedding-retrieval block. Such a retrieval block may be configured to retrieve K≥1 image embeddings from a predefined set of image embeddings, wherein the K retrieved image embedding are the K image embeddings with the largest cosine similarity with respect to the text embedding qtext generated by the text encoder 11 out of the set of image embeddings. The image embedding q'img to be used as input to the second generative model 13 may then be determined based on the K retrieved image embeddings. In implementations where K>1, the image embedding q'img may be determined as the average of the retrieved K image embeddings, or be randomly sampled from the retrieved K image embeddings. In implementations where K=1, the image embedding q'img may simply be determined as the image embedding out of the set of image embeddings with the largest cosine similarity with respect to the text embedding qtext. The set of image embeddings from which the retrieval block retrieves the K image embeddings may comprise image embeddings used to train the second generative model 13. It may hence be ensured that the image embedding q'img input to the second generative model 13 is, or is close to, the image embeddings used to train the second generative model 13.

At S3, a spectrogram X is synthesized by inputting the image embedding q'img to the second generative model 12. The second generative model 12 may as indicated in FIG. 2 be implemented as a diffusion decoder model, however other implementations are also possible such as a GAN or an autoregressive model. In either case, the image embedding q'img may be input as a condition vector to the second generative model 12. The second generative model 12 may for example be trained to synthesize a Mel spectrogram which may enable a compressed representation of the audio waveform A to be generated. However, other spectrogram representations are also compatible with the present disclosure.

At S4, the synthesized spectrogram X is converted to the audio waveform A by the third generative model 14. The third generative model 14 is trained to convert an input spectrogram X to an audio waveform A, i.e. an audio signal in the waveform domain. Various implementations of the third generative model 14 are possible, such as a GAN, an autoregressive model, or a diffusion model. An example of a GAN-based implementation is the Big VGAN neural vocoder model (S. Lee, W. Ping, B. Ginsburg, B. Catanzaro, and S. Yoon, “Big VGAN: A Universal Neural Vocoder with Large-Scale Training,” in Proc. International Conference on Learning Representations, 2023.”) Examples of diffusion-based models include “DiffWave” (Kong et al, “DiffWave: A Versatile Diffusion Model for Audio Synthesis”, https://doi.org/10.48550/arXiv.2009.09761) and “SpecGrad” (Koizumi et al, “SpecGrad: Diffusion Probabilistic Model based Neural Vocoder with Adaptive Noise Spectral Shaping”, https://doi.org/10.48550/arXiv.2203.16749).

Using both a pretrained prior and pretrained text and image encoders 11, 21 (e.g. CLIP) enables self-supervised implementation of the audio synthesis method and system 1. However, to facilitate the audio synthesis the second generative model 13 needs to be trained. As indicated above, the second generative model 13 may be trained to synthesize a spectrogram X using spectrograms and training image embeddings generated from video frames paired with audio. The second generative model 13 may hence be trained using audio-visual data derived from a training dataset of videos.

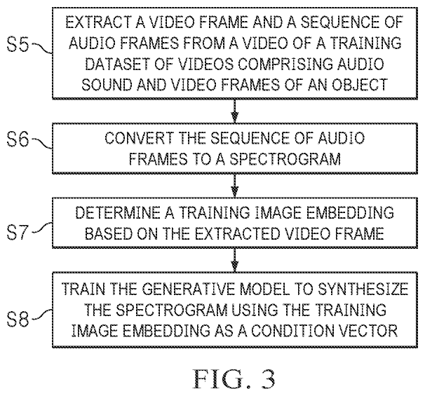

An example implementation of training the second generative model 13 from a training dataset of videos will now be described with reference to the flow chart of FIG. 3 and block diagram of FIG. 4, showing a training system 2.

The system 2 comprises in addition to the second generative model 13 to be trained, the image encoder 21. The image encoder 21 is as discussed above trained to map an input image I to a (training) image embedding qimg into the latent space shared with the text embeddings qtext generated by the text encoder 11 of the system 1 during testing/inference. The image encoder 21 may for example be a pretrained CLIP image encoder generating CLIP image embeddings. In any case, the image encoder 21 is trained before and frozen while training the second generative model 13.

At S5 a video frame (i.e. image) or a sequence of video frames I and a sequence of audio frames are extracted from a respective video V of a training dataset of videos {V} comprising audio sound A′ and video frames I. The video frame(s) may be extracted from a randomly selected segment of the video V. The segment may be of a predetermined or randomly selected length (e.g. within some suitable range).

At S6, the sequence of audio frames are converted to a spectrogram x0. The spectrogram x0 may as mentioned above be Mel spectrograms. The spectrogram x0 may be computed by an audio waveform-to-spectrogram conversion block 22.

At S7 an image embedding qimg to be input as a condition vector to the second generative model 13 is determined based on the extracted video frame(s) I. In an example implementation, a single video frame is extracted from the video V wherein the image embedding qimg may be determined by the image encoder 21 mapping the extracted video frame to an image embedding qimg and supplying the image embedding qimg to the second generative model 13.

In an example implementation, a sequence of video frames are extracted from the video V. The image encoder 21 may map each video frame of the sequence to a respective image embedding. The image embedding qimg to be input to the second generative model 13 may then be determined as an average of the image embeddings for the sequence of video frames, or randomly selected among the image embeddings.

At S8, the second generative model 13 is trained to synthesize the ground-truth spectrogram xo determined at step S6 using the image embedding qimg as a condition vector. The training process may be iterated over the training dataset of videos V.

The second generative model 12 may as previously mentioned be implemented as a diffusion model (as shown in FIG. 4). A denoising diffusion probabilistic model (see e.g. A. Nichol and P. Dhariwal, “Improved Denoising Diffusion Probabilistic Models,” in Proc. ICML, 2019) and classifier-free guidance (see e.g. T. S. Jonathan Ho, “Classifier-Free Diffusion Guidance,” in NeurIPS Workshop on Deep Generative Models and Downstream Applications, 2021) may be employed.

The second generative model 13 may for example be trained using the VGGSound dataset (Chen et al., “VGGSound: A Large-scale Audio-Visual Dataset”, arXiv:2004.14368, https://arxiv.org/pdf/2004.14368.pdf). Each video in the VGGSound dataset is 10 sec long, which contains audio sound and visual frames of an object. There are about 300 audio classes in this dataset. However, the VGGSound dataset is only one example, and other comparable datasets may be used, such as MUSIC (obtainable at https://github.com/roudimit/MUSIC_dataset), ACAV100M (obtainable at https://acav100m.github.io/), Ego4D (obtainable at https://ego4d-data.org/) or EPIC-SOUNDS (obtainable at https://epic-kitchens.github.io/epic-sounds/).

Although FIG. 4 shows the second generative model 13 as a diffusion model, other implementations of the second generative model 13 (e.g. GAN or an autoregressive model) may be trained in a corresponding fashion, as would be understood by a skilled person.

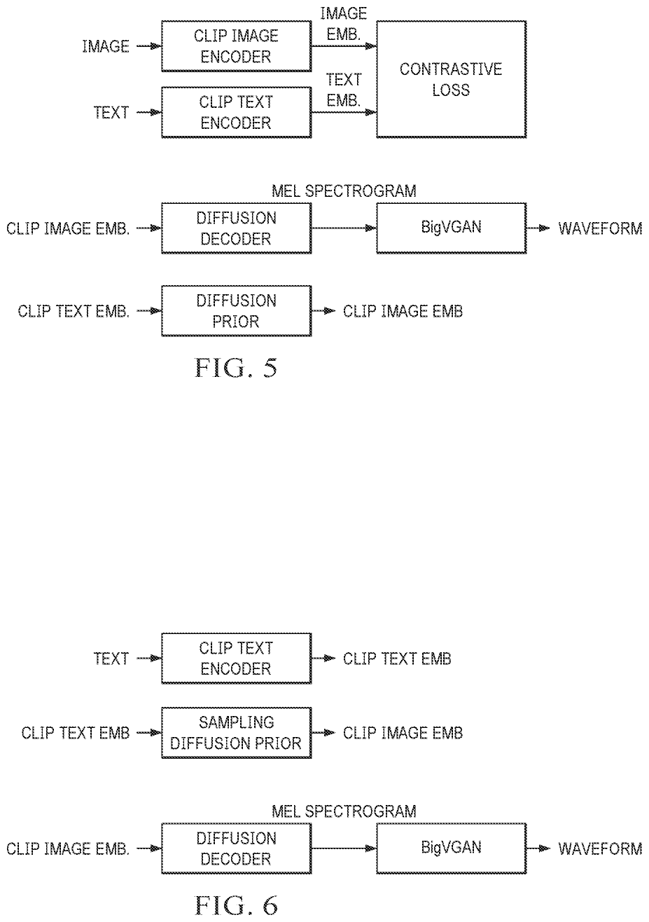

Further example implementations of a training system and testing system will now be described with reference to FIG. 5-6. It is to be noted that the various numerical examples relating to the models, the training and the testing are applicable also to the methods and systems discussed with reference to FIG. 1-4 above.

There are three components to be trained in FIG. 5. Each of them, as well as the components of the test system in FIG. 6, is described in the following:

CLIP image/text encoder: The training system uses a pretrained CLIP model to extract an embedding from an input image (at training time) or text (at testing time). CLIP is pretrained on ~400 million image-text pairs. As previously mentioned, it consists of an image encoder and a text encoder, which map the input image/text to an (ideally) shared latent space. The contrastive loss forces the embeddings of a matched image-text pair to have large cosine similarity, and the embeddings of a mismatched image-text pairs to have small cosine similarity. For example, the cosine similarity may be a measurement between 0 and 1, where values closer to 1 have a large cosine similarity. For example, a target cosine similarity for a matched text-image pair is 1, while a target cosine similarity for a mismatched text-image pair is 0. As another example, a large cosine similarity may be a larger value in contrast to a mismatched text-image pair's cosine similarity. This way, the embeddings of the two modalities (image, text) could be used interchangeably. In other words, the CLIP bridges the image and text modalities in audio synthesis.

Diffusion decoder and the Big VGAN: A diffusion model (corresponding to the second generative model 13) is trained on, for example, the aforementioned VGGSound dataset to synthesize a Mel spectrogram given a CLIP image embedding. Since this diffusion model “unCLIP” a CLIP embedding to a Mel spectrogram, it may be termed the diffusion decoder in this context. At training time, a X-length segment is randomly taken from a video (e.g., X can be anywhere from 1-100 seconds, 1-1000, etc.). Image frames are extracted at Y frames per second (e.g., 1-10 frames per second, 1-100 frames per second, etc), and audio frames every 8-32 ms with a window size of 40-128 ms. The audio is resampled to e.g., 16 kHz. Then, each audio frame is converted to 40-128 Mel bands. A frame is randomly selected out of the X*Y image frames and a CLIP image embedding is extracted using the pretrained CLIP image encoder. In some embodiments, the CLIP image embedding may be an average of the CLIP embeddings of all the frames. The diffusion model may follow the UNet DDPM architecture (Ho et al., “Denoising Diffusion Probabilistic Models”, arXiv:2006.11239v2, https://arxiv.org/pdf/2006.11239.pdf), and is trained to synthesize the Mel spectrogram of the target audio given the CLIP image embedding as the condition vector. Finally, the BigVGAN is trained to convert the Mel spectrogram to an audio waveform. The Big VGAN is trained on the ground truth Mel spectrograms also from VGGSound. Note that compared with directly synthesizing a waveform, the present diffusion model generates a highly compressed Mel spectrogram. This choice greatly eases the task for the diffusion model as it works in a much lower dimensional space. Meanwhile, a powerful vocoder (the Big VGAN) reconstructs the spectral-temporal details from the lossy Mel spectrograms.

Diffusion prior: At test time, one could in practice take a textual description of the desired sound, convert it to a text embedding using the pretrained CLIP text encoder, and synthesize an audio according to that text. Ideally, the contrastive learning paradigm in CLIP would project the text embedding and the image embedding of a matched text-image pair as close embedding vectors in the shared latent space of the CLIP text encoder and the image encoder. However, as discussed above, in practice, there is usually a gap between the two modalities in this space. Since the diffusion decoder only sees CLIP image embeddings at training time, large quality degradation may be observed when switching to CLIP text embeddings at test time. For example, the cosine similarity for a matched text-image pair may be e.g., 0.2-0.3 (showing a gap). Therefore, the further diffusion model, i.e. the diffusion prior, is used to learn a prior distribution of the CLIP image embeddings generated by the CLIP image encoder given a CLIP text embedding (thus the name diffusion prior). By sampling from this prior distribution, CLIP embeddings may be obtained that are closer to the CLIP image embeddings used during training the diffusion decoder in the previous step. It may be noted that this approach resembles the diffusion prior method proposed in “Hierarchical Text-Conditional Image Generation with CLIP Latents” (Ramesh et al., arXiv:2204.06125, https://arxiv.org/pdf/2204.06125.pdf), in which a text-to-image synthesis system is developed, and the diffusion prior is used to generate a CLIP image embedding from a text description, which is then used to synthesize an image by a diffusion decoder. However, since the CLIP model itself is pretrained on image-text pairs, for a text-to-image synthesis task, even without using the prior to bridge the text-image gap, the synthesized image quality may not degrade significantly. Thus, this is very different from the audio synthesis task of the present example, since the CLIP model is never trained on audio.

In order to train the diffusion prior, one would need text-image pairs. However, to enable an un- or self-supervised setting, a pretrained diffusion prior model may be used, such as the transformer-based diffusion prior model obtainable at https://huggingface.co/laion/DALLE2-PyTorch. This diffusion prior model may follow the transformer architecture presented by Ramesh et al. and is trained on 2 billion text-image pairs. Note that none of the text is audio related.

FIG. 6 shows the processing during inference. Given a text description, the pretrained CLIP text encoder computes a text embedding, which is then converted to a CLIP image embedding by sampling from the learned prior distribution of the image embedding. Given a CLIP text embedding, N image embeddings are randomly sampled from the prior distribution (e.g. N=2) and the one with the larger cosine similarity with the text embedding is selected. Finally, this image embedding is sent to the trained diffusion decoder to obtain the synthesized Mel spectrogram, which is converted to an audio waveform by the BigVGAN.

Instead of training a diffusion prior, a simple “zero-shot retrieval method” may be used to bridge the gap between the CLIP text and image embeddings. At training time, this approach stores the CLIP image embeddings of all the images from either the training set of the diffusion decoder or an even larger image dataset. At testing time, given a CLIP text embedding, the K best stored CLIP image embedding which has the largest cosine similarity with the text embedding may be retrieved. Either the top-1 or the average of the top-K image embeddings may then be used to synthesize the audio.

The three specific generative models referred to in the above examples (the diffusion decoder, Big VGAN, and the diffusion prior) are exemplary and can be substituted by any generative models, such as generative adversarial networks (GANs), autoregressive models, etc., all of which are within the scope of this disclosure.

Systems and methods disclosed in the present disclosure may be implemented as software, firmware, hardware or a combination thereof. In a hardware implementation, the division of tasks does not necessarily correspond to the division into physical units; to the contrary, one physical component may have multiple functionalities, and one task may be carried out by several physical components in cooperation.

The computer hardware may for example be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions (sequential or otherwise) that specify actions to be taken by that computer hardware. Further, the present disclosure shall relate to any collection of computer hardware that individually or jointly execute instructions to perform any one or more of the concepts discussed herein.

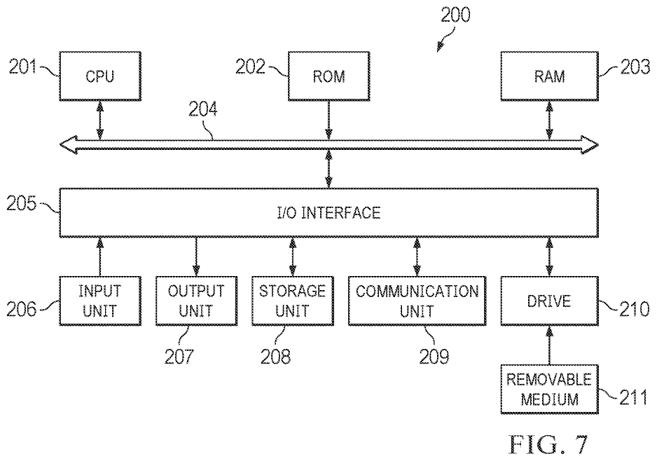

FIG. 7 shows a schematic block diagram of an example electronic device, system or architecture 200 (e.g., an apparatus 200) suitable for implementing example embodiments of the present disclosure. Architecture 200 includes but is not limited to the system 1 of FIG. 2, the system 2 of FIG. 4, the training and testing systems of FIG. 5-6, and the implementation of methods as described in relation to FIG. 1-6. As shown, the architecture 200 includes central processing unit (CPU) 201 which is capable of performing various processes in accordance with a program stored in, for example, read only memory (ROM) 202 or a program loaded from, for example, storage unit 208 to random access memory (RAM) 203. The CPU 201 may be, for example, an electronic processor 201, which may include one or more processor cores, and in some examples the processor 201 may be multiple processors. In RAM 203, the data required when CPU 201 performs the various processes is also stored, as required. CPU 201, ROM 202 and RAM 203 are connected to one another via bus 204. Input/output (I/O) interface 205 is also connected to bus 204.

The following components are connected to I/O interface 205: input unit 206, that may include a keyboard, a mouse, or the like; output unit 207 that may include a display such as a liquid crystal display (LCD) and one or more speakers; storage unit 208 including a hard disk, or another suitable storage device; and communication unit 209 which may include a network interface card such as a network card (e.g., wired or wireless).

In some implementations, input unit 206 includes one or more microphones in different positions (depending on the host device) enabling capture of audio signals in various formats (e.g., mono, stereo, spatial, immersive, and other suitable formats).

In some implementations, output unit 207 include systems with various number of speakers. Output unit 207 (depending on the capabilities of the host device) can render audio signals in various formats (e.g., mono, stereo, immersive, binaural, and other suitable formats).

In some implementations, communication unit 209 is configured to communicate with other devices (e.g., via a network). Drive 210 is also connected to I/O interface 205, as required. Removable medium 211, such as a magnetic disk, an optical disk, a magneto-optical disk, a flash drive or another suitable removable medium is mounted on drive 210, so that a computer program read therefrom is installed into storage unit 208, as required. A person skilled in the art would understand that although apparatus 200 is described as including the above-described components, in real applications, it is possible to add, remove, and/or replace some of these components and all these modifications or alteration all fall within the scope of the present disclosure.

In accordance with example embodiments of the present disclosure, the processes described above may be implemented as computer software programs or on a computer-readable storage medium. For example, embodiments of the present disclosure include a computer program product including a computer program tangibly embodied on a machine readable medium, the computer program including program code for performing methods. In such embodiments, the computer program may be downloaded and mounted from the network via the communication unit 209, and/or installed from the removable medium 211, as shown in FIG. 7.

Generally, various example embodiments of the present disclosure may be implemented in hardware or special purpose circuits (e.g., control circuitry), software, logic or any combination thereof. For example, the various elements of FIGS. 2 and 4 discussed above can be executed by control circuitry (e.g., CPU 201 in combination with other components of FIG. 7), thus, the control circuitry may be performing the actions described in this disclosure.

Some aspects may be implemented in hardware, while other aspects may be implemented in firmware or software which may be executed by a controller, a processor and/or other computing device(s), which may include control circuitry. While various aspects of the example embodiments of the present disclosure are illustrated and described as block diagrams, flowcharts, or using some other pictorial representation, it will be appreciated that the blocks, apparatus, systems, techniques, or methods described herein may be implemented in, as non-limiting examples, hardware, software, firmware, special purpose circuits or logic, general purpose hardware or controller or other computing devices, or some combination thereof.

Additionally, various blocks shown in the flowcharts may be viewed as method steps, and/or as operations that result from operation of computer program code, and/or as a plurality of coupled logic circuit elements constructed to carry out the associated function(s). For example, embodiments of the present disclosure include a computer program product including a computer program tangibly embodied on a machine readable medium, the computer program containing program codes configured to carry out the methods as described above.

Computer program code for carrying out methods of the present disclosure may be written in any combination of one or more programming languages. These computer program codes may be provided to one or more processors of a general-purpose computer, special purpose computer, or other programmable data processing apparatus that has control circuitry, such that the program codes, when executed by one or more processors of the computer or other programmable data processing apparatus, cause the functions/operations specified in the flowcharts and/or block diagrams to be implemented. The program code may execute entirely on a computer, partly on the computer, as a stand-alone software package, partly on the computer and partly on a remote computer or entirely on the remote computer or server or distributed over one or more remote computers and/or servers.

The one or more processors may operate as a standalone device or may be connected, e.g., networked to other processor(s). Such a network may be built on various different network protocols, and may be the Internet, a Wide Area Network (WAN), a Local Area Network (LAN), or any combination thereof.

The software may be distributed on computer readable media, which may comprise computer storage media (or non-transitory media) and communication media (or transitory media). As is well known to a person skilled in the art, the term computer storage media includes both volatile and non-volatile, removable and non-removable media implemented in any method or technology for storage of information such as computer readable instructions, data structures, program modules or other data. Computer storage media includes, but is not limited to, physical (non-transitory) storage media in various forms, such as ROM, PROM, EPROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer. Further, it is well known to the skilled person that communication media (transitory) typically embodies computer readable instructions, data structures, program modules or other data in a modulated data signal such as a carrier wave or other transport mechanism and includes any information delivery media.

The implementation of the technologies disclosed in the figures are merely illustrative examples, and the invention is not so limited. For example, the illustrated partitions such as blocks in FIGS. 2, 4, 5 and 6 are merely illustrative logical partitions for ease of discussion, where such partitions may be split into additional partitions, combined into fewer partitions, supplemented with additional partitions, or reduced by eliminating partitions, without departing from the spirit of the present invention. For the illustrated flow charts of FIGS. 1 and 3, the partitions of the operational steps, which may be also referred to as functions, steps, operations, processes, or acts, may be combined into fewer steps or split into additional steps, where steps may be reordered or eliminated, in whole or in part, without departing from the spirit of this disclosure.

Unless specifically stated otherwise, as apparent from the following discussions, it is appreciated that throughout the disclosure discussions utilizing terms such as “processing”, “computing”, “calculating”, “determining”, “analyzing” or the like, may refer to the function, action, steps and/or processes of a computer hardware or computing system, or similar electronic computing devices, that manipulate and/or transform data represented as physical, such as electronic, quantities into other data similarly represented as physical quantities.

It should be appreciated that in the above description of example embodiments of the invention, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention. Furthermore, while some embodiments described herein include some, but not other, features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with instructions for carrying out such a method or element of a method forms a means for carrying out the method or element of a method. Note that when the method includes several elements, e.g., several steps, no ordering of such elements is implied, unless specifically stated. Furthermore, an element described herein of an apparatus embodiment is an example of a means for carrying out the function performed by the element for the purpose of carrying out the embodiments of the invention. In the description provided herein, numerous specific details are set forth. However, it is understood that embodiments of the invention may be practiced without these specific details. In other instances, well-known methods, structures and techniques have not been shown in detail in order not to obscure an understanding of this description.

Various aspects of the present disclosure may be appreciated from the following enumerated example embodiments (“EEEs”):

EEE 1. A method for synthesizing an audio waveform from a text description indicating a desired sound, the method comprising:
determining a text embedding from the text description;
determining an image embedding from the text embedding;
synthesizing a spectrogram by inputting the image embedding to a generative model trained to synthesize a spectrogram given an input image embedding; and
converting the synthesized spectrogram to the audio waveform.

EEE 2. The method according to EEE 1, wherein the text embedding is generated using a text encoder trained to map an input text description to a text embedding in a latent space shared with image embeddings used to train the generative model to synthesize a spectrogram.

EEE 3. The method according to EEE 2, wherein the image embeddings used to train the generative model are generated using an image encoder trained to map an input image to an image embedding in the latent space, wherein the text encoder and the image encoder are trained jointly using a contrastive loss.

EEE 4. The method according to EEE 3, wherein the text encoder is a Contrastive Language-Image Pre-Training (CLIP) text encoder and the image encoder is a CLIP image encoder.

EEE 5. The method according to any one of the preceding EEEs, wherein the text embedding is a CLIP text embedding and wherein the generative model is trained to synthesize a spectrogram given a CLIP image embedding.

EEE 6. The method according to any one of the preceding EEEs, wherein the generative model is a second generative model and wherein the image embedding is determined using a first generative model trained to convert an input text embedding to an image embedding.

EEE 7. The method according to EEE 6, wherein determining the image embedding from the text embedding comprises sampling N image embeddings from a distribution of image embeddings generated by the first generative model given the text embedding as input, and selecting the image embedding out of the N image embeddings with a larger similarity to the text embedding.

EEE 8. The method according to EEE 7, wherein the selected image embedding is the image embedding out of the N image embeddings with the larger cosine similarity to the text embedding.

EEE 9. The method according to any one of EEEs 7-8, wherein the first generative model is a prior, such as a diffusion prior.

EEE 10. The method according to EEE 9, when dependent on EEE 3, wherein the prior is trained to model a distribution of image embeddings generated by the image encoder, conditioned on text embeddings generated by the text encoder.

EEE 11. The method according to any one of EEEs 6-10, wherein the prior is trained to generate a CLIP image embedding given an input CLIP text embedding.

EEE 12. The method according to any one of EEEs 1-5, wherein determining the image embedding comprises retrieving K≥1 image embeddings from a set of image embeddings, wherein the K retrieved image embedding are the K image embeddings with the largest cosine similarity with respect to the text embedding out of the set of image embeddings, and wherein the image embedding is determined based on the K retrieved image embeddings.

EEE 13. The method according to EEE 12, wherein K=1 and the image embedding is determined as the retrieved image embedding, or wherein K>1, and wherein the image embedding is determined as the average of the retrieved K image embeddings, or is randomly sampled from the retrieved K image embeddings.

EEE 14. The method according to any one of EEEs 12-13, when dependent on EEE 2, wherein the set of image embeddings comprises image embeddings used to train the second generative model.

EEE 15. The method according to any one of the preceding EEEs, wherein the generative model synthesizing the spectrogram comprises a diffusion decoder model, a generative adversarial network (GAN) or an autoregressive model, wherein the image embedding is input as a condition vector to the generative model.

EEE 16. The method according to any one of the preceding EEEs, wherein the generative model is trained to synthesize a Mel spectrogram.

EEE 17. The method according to any one of the preceding EEEs, wherein the synthesized spectrogram is converted to the audio waveform by inputting the synthesized spectrogram to a third generative model trained to convert an input spectrogram to an audio waveform.

EEE 18. The method according to EEE 17, wherein the third generative model comprises a diffusion model, generative adversarial network or an autoregressive model.

EEE 19. The method according to any one of the preceding EEEs, wherein the generative model is trained to synthesize a spectrogram using spectrograms and training image embeddings generated from video frames paired with audio.

EEE 20. The method according to EEE 19, wherein training the generative model comprises:
extracting a video frame and a sequence of audio frames from a video of a training dataset of videos comprising audio sound and video frames of an object;
converting the sequence of audio frames to a spectrogram;
determining a training image embedding based on the extracted video frame; and
training the generative model to synthesize the spectrogram using the training image embedding as a condition vector.

EEE 21. The method according to EEE 20, wherein the training comprises extracting a sequence of video frames from the video, determining a sequence of training image embeddings from the extracted sequence of video frames, and determining the training image embedding as an average image embedding of the sequence of training image embeddings.

EEE 22. The method according to any one of EEEs 19-21, when dependent on EEE 3, wherein the training image embedding is determined using the image encoder.

EEE 23. A system for synthesizing an audio waveform from a text description, the system configured to implement the method according to any one of the preceding EEEs.

EEE 24. A computer program product comprising computer program code portions configured to perform the method according to any one of EEEs 1-22 when executed on a computer processor.

EEE 25. An unsupervised deep learning method for synthesizing an audio waveform from a text description describing a desired sound, the method comprising:
determining a text embedding from the text description;
converting the text embedding to an image embedding by sampling from a
learned prior distribution of the image embedding;
selecting an image embedding sampled from the learned prior distribution with a large cosine similarity with the text embedding;
determining a synthesized Mel spectrogram based on the selected image embedding; and
converting the synthesized Mel spectrogram to the audio waveform.

EEE 26. An unsupervised deep learning system for synthesizing an audio waveform from a text description describing a desired sound, the system comprising:
a neural network model configured to:
   determine a text embedding from the text description;
a first generative model configured to:
   convert the text embedding to an image embedding by sampling from a learned prior distribution of the image embedding; and
   select an image embedding randomly sampled from the prior distribution with a large cosine similarity with the text embedding;
a second generative model configured to:
   determine a synthesized Mel spectrogram based on the selected image embedding; and
a third generative model configured to:
   convert the synthesized Mel spectrogram to the audio waveform.

EEE 27. The system of EEE 26, wherein at least one of the first generative model and/or the second generative model is configured to be trained via a dataset that is absent of audio-related texts.

EEE 28. The system of EEE 26 or EEE 27, wherein the neural network model comprises a Contrastive Language-Image Pre-Training (CLIP) model, the first generative model comprises a diffusion prior model, the second generative model comprises a diffusion decoder model, and/or the third generative model comprises a Big VGAN model.

EEE 29. The system of any one of EEEs 26-28, wherein the first generative model, the second generative model, and the third generative model each comprise at least one of a generative adversarial network (GAN) and/or an autoregressive model.

EEE 30. The system of any one of EEEs 26-29, wherein the text embedding comprises a CLIP text embedding and the image embedding comprises a CLIP image embedding.

EEE 31. An unsupervised deep learning system for synthesizing an audio waveform from a text description describing a desired sound, the system comprising:
a neural network model configured to:
   determine a text embedding from the text description;
a retrieval module configured to:
   retrieve an image embedding from a set of image embeddings, wherein the retrieved image embedding has the largest cosine similarity with respect to the text embedding out of the set of image embeddings;
a first generative model configured to:
   determine a synthesized Mel spectrogram based on the selected image embedding; and
a second generative model configured to:
   convert the synthesized Mel spectrogram to the audio waveform.

EEE 32. The system of EEE 31, wherein the neural network model comprises a Contrastive Language-Image Pre-Training (CLIP) model, the first generative model comprises a diffusion decoder model, and/or the second generative model comprises a Big VGAN model.

EEE 33. The system of EEE 31 or 32, wherein the first generative model and the second generative model each comprise at least one of a generative adversarial network (GAN) and/or an autoregressive model.

EEE 34. The system of any one of EEEs 31-33, wherein the text embedding comprises a CLIP text embedding and the image embedding comprises a CLIP image embedding.

EEE 35. An apparatus, comprising a processor and a memory coupled to the processor, wherein the processor is adapted to carry out the method according to EEE 25.

EEE 36. A program comprising instructions that, when executed by a processor, cause the processor to carry out the method according to EEE 1.

1. A method for synthesizing an audio waveform from a text description indicating a desired sound, the method comprising:
determining a text embedding from the text description;
determining an image embedding from the text embedding;
synthesizing a spectrogram by inputting the image embedding to a generative model trained to synthesize a spectrogram given an input image embedding; and
converting the synthesized spectrogram to the audio waveform.

2. The method according to claim 1, wherein the text embedding is generated using a text encoder trained to map an input text description to a text embedding in a latent space shared with image embeddings used to train the generative model to synthesize a spectrogram.

3. The method according to claim 2, wherein the image embeddings used to train the generative model are generated using an image encoder trained to map an input image to an image embedding in the latent space, wherein the text encoder and the image encoder are trained jointly using a contrastive loss.

4. The method according to claim 3, wherein the text encoder is a Contrastive Language-Image Pre-Training (CLIP) text encoder and the image encoder is a CLIP image encoder.

5. The method according to claim 1, wherein the text embedding is a CLIP text embedding and wherein the generative model is trained to synthesize a spectrogram given a CLIP image embedding.

6. The method according to claim 1, wherein the generative model is a second generative model and wherein the image embedding is determined using a first generative model trained to convert an input text embedding to an image embedding.

7. The method according to claim 6, wherein determining the image embedding from the text embedding comprises sampling N image embeddings from a distribution of image embeddings generated by the first generative model given the text embedding as input, and selecting the image embedding out of the N image embeddings with a larger similarity to the text embedding.

8. The method according to claim 7, wherein the selected image embedding is the image embedding out of the N image embeddings with the larger cosine similarity to the text embedding.

9. The method according to claim 7, wherein the first generative model is a prior, such as a diffusion prior.

10. (canceled)

11. The method according to claim 6, wherein the prior is trained to generate a CLIP image embedding given an input CLIP text embedding.

12. The method according to claim 1, wherein determining the image embedding comprises retrieving K≥1 image embeddings from a set of image embeddings, wherein the K retrieved image embedding are the K image embeddings with the largest cosine similarity with respect to the text embedding out of the set of image embeddings, and wherein the image embedding is determined based on the K retrieved image embeddings.

13. The method according to claim 12, wherein K=1 and the image embedding is determined as the retrieved image embedding, or wherein K>1, and wherein the image embedding is determined as the average of the retrieved K image embeddings, or is randomly sampled from the retrieved K image embeddings.

14. (canceled)

15. The method according to claim 1, wherein the generative model synthesizing the spectrogram comprises a diffusion decoder model, a generative adversarial network (GAN) or an autoregressive model, wherein the image embedding is input as a condition vector to the generative model.

16. The method according to claim 1, wherein the generative model is trained to synthesize a Mel spectrogram.

17. The method according to claim 1, wherein the synthesized spectrogram is converted to the audio waveform by inputting the synthesized spectrogram to a third generative model trained to convert an input spectrogram to an audio waveform.

18. The method according to claim 17, wherein the third generative model comprises a diffusion model, generative adversarial network or an autoregressive model.

19. The method according to claim 1, wherein the generative model is trained to synthesize a spectrogram using spectrograms and training image embeddings generated from video frames paired with audio.

20. The method according to claim 19, wherein training the generative model comprises:
extracting a video frame and a sequence of audio frames from a video of a training dataset of videos comprising audio sound and video frames of an object;
converting the sequence of audio frames to a spectrogram;
determining a training image embedding based on the extracted video frame; and
training the generative model to synthesize the spectrogram using the training image embedding as a condition vector.

21. (canceled)

22. (canceled)

23. A system for synthesizing an audio waveform from a text description, the system configured to implement the method according to any one of the preceding claims.

24. A computer program product comprising computer program code portions configured to perform the method according to claim 1 when executed on a computer processor.
